(19) United States
(12) Patent Application Publication
(10) Pub. No.: US 2009/0050075 A1
(43) Pub. Date: Feb. 26, 2009

(54) Peacemaker

(75) Inventor: Richard Samaniego, Fort Worth, TX (US)

Correspondence Address: Innovative Bird Solutions, LLC;Attn: Thomas F. Dunn, Manager, Suite 150, 4025 Woodland Park Blvd., Arlington, TX, 76013, US

(73) Assignee: Innovative Bird Solutions, LLC, Arlington, TX (US)

(21) Appl. No.: 11/895,297

(22) Filed: Aug. 24, 2007

(51) Int. Cl. A01K 29/00

(52) U.S. Cl. 119/713

(57) ABSTRACT

The invention provides a method and apparatus for repelling grackles away from their tree roosts by continuously or intermittently (i) moving/rustling limbs, branches and leaves in the tree and (ii) causing low decibel sounds to be emanated that scare grackles and disrupts the natural roosting environment. The invention is cost effective, non-lethal to the grackles, and uses no chemicals/pesticides. The invention protects property and person from the damaging, unhealthy and annoying effects of grackle waste droppings and crowing noise. The invention contributes to the profitability of commercial enterprise by repelling and averting grackles away from trees on or near (i) fields used by farmers for growing crops such that the crops and seedlings will not be eaten by nearby roosting grackles, and/or (ii) retail commercial establishments such that customers will not avoid patronizing the nearby merchants simply because of the presence of grackles and their noises and droppings.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

1. Field of the Invention

This disclosure relates to the field of pest control technology, and more specifically, to methods and apparatus for controlling and repelling the roosting and migratory patterns and habits of the common grackle (Quiscalus quiscula) and other species of birds. The method and apparatus may be used to cause grackles and other birds to flee and relocate from trees and other vegetation in which they are currently roosting or return to roost during various parts of the day, including the early morning, daylight hours and evening (dusk to dawn) hours.

2. Description of the Related Art

The common grackle and other species of birds cause extensive damage to commercial and residential property primarily in the form of their natural waste droppings which fall on any nearby objects such as yards, sidewalks, cars, buildings, roofs, awnings, flower beds, parks, streets, and people. These droppings smell, can stain, discolor and disfigure property upon which they fall, and also present a health hazard in the form of the natural germs and diseases inherent in the droppings themself. In addition, the droppings attract other insects, pests and varmints.

The common grackle and other species of birds also negatively impact and damage the environment, quality of life and commercial profitability of (i) people who reside in areas where grackles and other birds roost and/or (ii) commercial business establishments such as restaurants, parks and retail businesses which are operated or located at or near areas where grackles and other birds roost. In addition to the damages caused by their droppings as discussed above in paragraph 008, the grackles and other birds make loud chirps, crows and audible sounds that are very annoying to people and other animals because the grackles and other birds tend to roost and flock in very large numbers. The grackles and other birds also cause customers of commercial business establishments to take their business to other merchants and/or locations because the customers don't like to hear the noise from the birds, to see or walk through or over their droppings on the ground, and/or have the droppings fall on them, their property or their automobiles.

The common grackle and other birds also cause extensive damage to crops and edible fruit being grown by farmers in Texas, Louisiana and other states. The grackles and other birds will leave the trees or other vegetation in which they roost to feed and eat the farmer's growing and/or planted crops and edible fruits, including, but not limited to, rice, nuts, seeds, seedlings, plants, lettuce, corn, sunflowers, fruit and nuts.

Current methods for dealing with the problems generated by the grackles and other birds include limited chemical and certain non-chemical hazing methods. Chemical methods of grackle and bird control are not allowable in all states or other local jurisdictions, they pose health, safety and environmental pollution problems of their own, and are generally objected to by the public if they result in the killing of the grackles and birds. Non-chemical hazing control of the grackles involves some or all of the following: human manual shaking of trees and roosts; bright laser lights; making loud noises from shot guns; making loud noise from other mechanical or artificial noise making devices; artificial predator calls; and daily clean up and power washing of grackle droppings. All of these methods are very expensive, labor intensive and are in many cases themselves annoying and objectionable to the general public (e.g., bright laser lights and loud noise making devices). Further, such methods are not effective on a long-term basis because the grackles will tend to (i) become used to the generated noises and/or artificial predator calls, and (ii) return to trees soon after the manual shaking or shining of lights into the trees is stopped. Each of the existing methods and systems discussed above suffer from one or more drawbacks that make their use less than optimal under all circumstances. Thus, there continues to be a need for a non-lethal, non-chemical, environmentally friendly, and effective method and system for the management of grackle and bird related problems. The invention address and solves those problems as to tree roosting grackles and birds.

### BRIEF SUMMARY OF THE INVENTION

The invention generally relates to a method for repelling and averting grackles and other roosting birds from trees in which they roost. The method does not use chemicals, pesticides, or other currently ineffective hazing techniques such as human manual shaking of trees and roosts; bright laser lights; making loud noises from shot guns; making loud noise from other mechanical or artificial noise making devices; artificial predator calls; and daily clean up and power washing of grackle droppings.

In one aspect, the invention includes a method for repelling, relocating and averting grackles and other roosting birds from trees. The method is implemented by installing a mechanically operated device horizontally to the main trunk of the tree and extending vertically along the tree trunk axis all the way to the highest point of the canopy of the tree where the grackles/birds roost or nest in trees. The device moves in a rotary manner which causes the moving rods and parts to rattle, agitate, and hits against tree limbs and branches located in the canopy (all the way to the highest point of the canopy) of the tree where the birds roost or nest. The action, force and interaction of the device with the tree causes the limbs, branches and leaves of the tree to move and rustle, and also produces a low decibel sound emanating from the whipping and turning of the device extensions rods in the area of the tree canopy. The period of time during which the method and device are operated can be permanent or intermittent based on a motor timer mechanism that comprises a part of the device. The combination of timed tree movement, rustling, sounds and noises caused or emitted by the moving parts of the device causes the grackles to fly away from the roosting tree and, based on field tests, surrounding trees as well. Based on observations during field tests of the apparatus, grackles were repelled from nearby trees in which the apparatus was not installed apparently because of the flocking traits of the grackles—the grackles appear to be flocking birds and the less dominiant birds will follow the dominant alpha grackles as they relocate from the tree in which the device is installed. Thus, the method included targeting of the alpha dominant grackles which tend to roost in the highest point of the canopy of the largest tree. The grackles tend not to return to the tree because of the ongoing operation of the device as determined by timer mechanism. The implementation of the method and device is more fully discussed in the “Brief Description of the Several Views of the Drawing” and the “Detailed Description of the Invention” section of this specifications below.

Another aspect relates to a system and apparatus installed horizontally to the main trunk of a tree and extending vertically along the tree trunk axis all the way to the highest point of the canopy of the tree where the grackles/birds roost or nest in trees. The moving parts of the apparatus rattle, agitate, and hit against tree limbs and branches and such actions and movements causes the tree limbs, branches and leaves to move and rustle, and also produces a low decibel sound emanating from the whipping and turning of the device extensions rods in the tree and tree canopy. The period of time during which the method and device are operated can be permanent or intermittent based on a motor timer mechanism that comprises a part of the device. The timed tree movement and rustling combined with the sound emanated by the moving parts of the device causes the grackles to fly away from the roosting tree and, based on field tests, surrounding trees as well. Based on observations during field tests of the apparatus, grackles were repelled from nearby trees in which the apparatus was not installed apparently because of the flocking traits of the grackles—the grackles appear to be flocking birds and the less dominant birds will follow the dominant alpha grackles as they relocate from the tree in which the device is installed. Thus, the method included targeting of the alpha dominant grackles which tend to roost in the highest point of the canopy of the largest tree. The grackles tend not to return to the tree because of the ongoing operation of the device as determined by timer mechanism. The grackles do not return to the trees because of the ongoing operation of the device as determined by timer mechanism. The operation of the device is more fully discussed in the “Brief Description of the Several Views of the Drawing” and the “Detailed Description of the Invention” section of this specifications below.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the inventions may be practiced.

### BRIEF DESCRIPTION OF THE SEVERAL VIEWS OF THE DRAWING

1. The invention is now described by way of example with reference to the accompanying drawings.

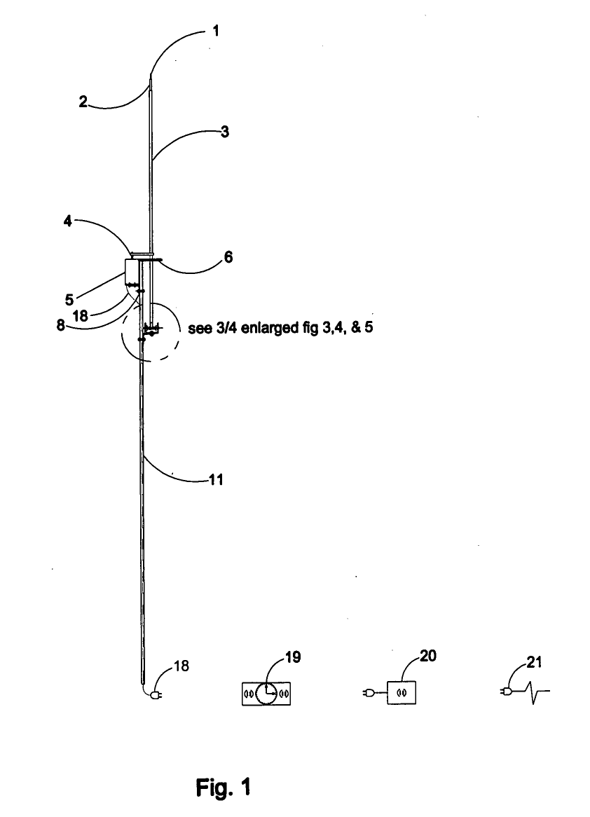

2. FIG. 1 is a side view combination of elements of one specific embodiment of a mechanical bird repellant and timer in addition wherein a power supply is conditioned of this invention.

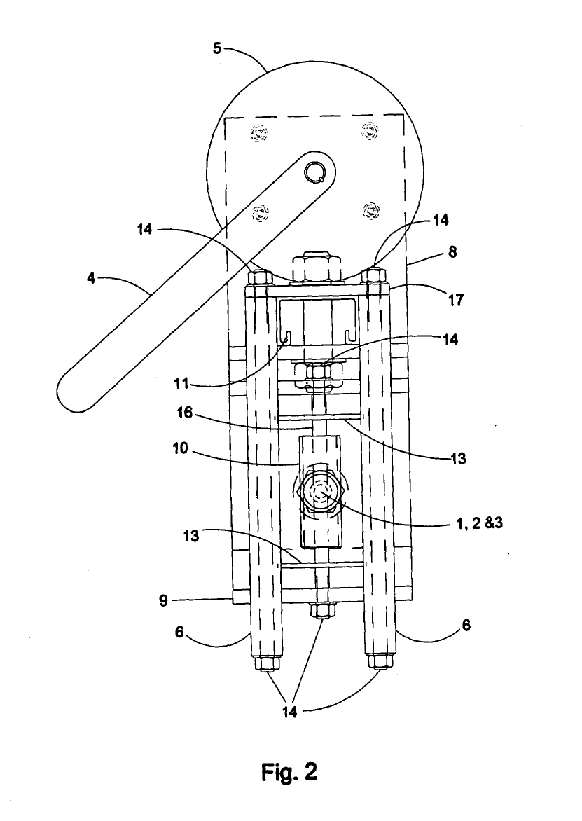

3. FIG. 2 is an enlarged top view of another specific embodiment of the combination of the mechanical bird repellant motor driven actuator and interference rattler wherein the mechanical operation is restricted of this invention.

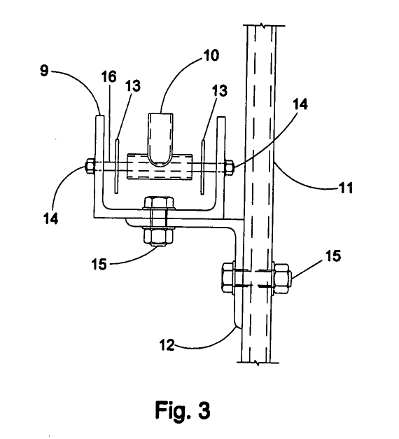

4. FIG. 3 is an enlarged partial side view of another specific embodiment of a mechanical bird repellant of this invention thereof.

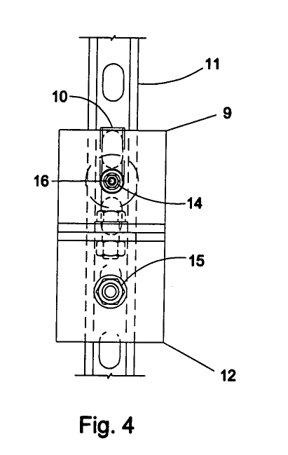

5. FIG. 4 is an enlarged partial front view of another specific embodiment of a mechanical bird repellant of this invention thereof.

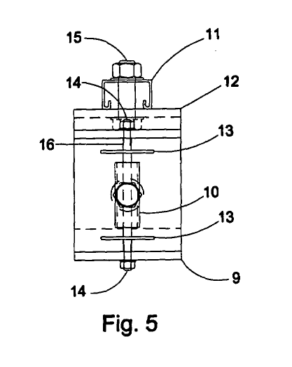

6. FIG. 5 is an enlarged partial top view of another specific embodiment of a mechanical bird repellant of this invention.

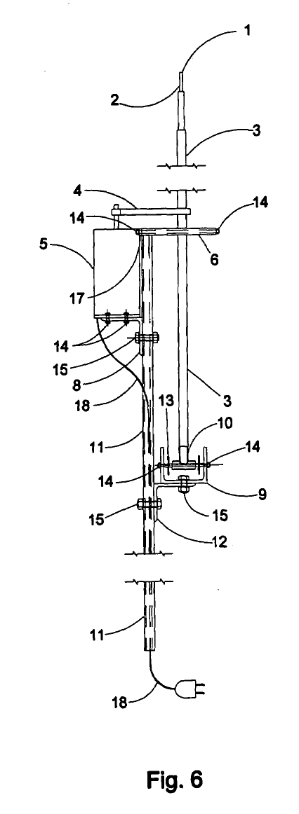

7. FIG. 6 is an enlarged side view of still another specific embodiment of a mechanical bird repellant of this invention thereof.

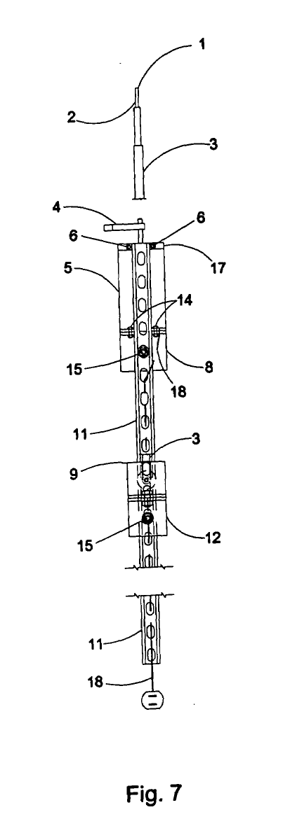

8. FIG. 7 is an enlarged front view of another specific embodiment of a mechanical bird repellant of this invention.

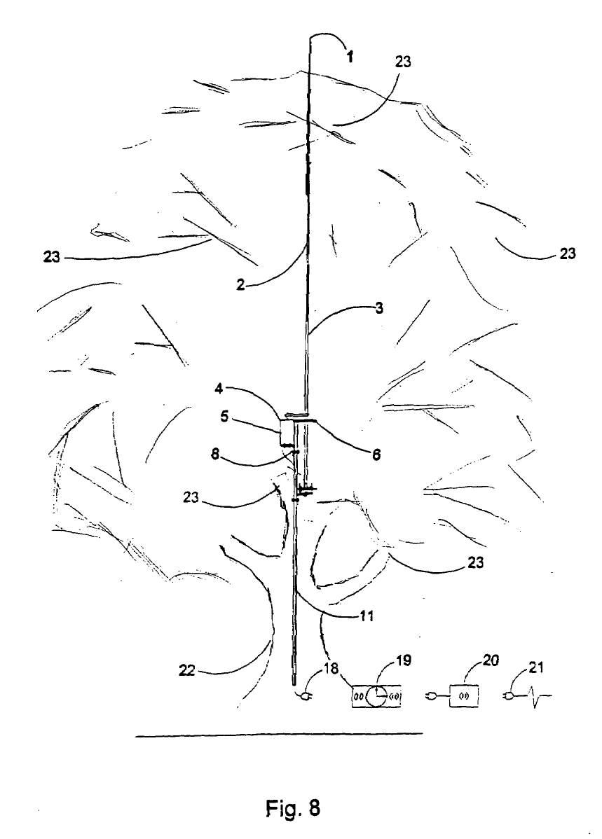

9. FIG. 8 is an elevation side view of specific embodiment method of a mechanical bird repellant of this invention.

### DETAILED DESCRIPTION OF THE INVENTION

The following detailed description of the invention is presented to enable any person skilled in the art to make and use the invention. For purposes of explanation, specific details are set forth to provide a thorough understanding if the present invention. However, it will be apparent to one skilled in the art that these specific details are not required to practice the invention. Various modifications to the preferred embodiments will be readily apparent to one skilled in the art, and the general principles defined herein may be applied to other embodiments and applications without departing from the scope of the invention. The present invention is not intended to be limited to the embodiment shown, but is to be accorded the widest possible scope consistent with the principles and features disclosed herein.

The present invention is based on the discovery that grackles will be repelled and averted and relocated from trees in which they roost if a continuous or intermittent force is applied in a manner which (i) causes the branches, limbs and leaves of a tree, especially in the area of the upper canopy of the tree, to move and (ii) creates low decibel sounds that scares the grackles and disrupts the normal environment in which they roost. The method does not use chemicals, pesticides, or other currently ineffective hazing techniques such as human manual shaking of trees and roosts; bright laser lights; making loud noises from shot guns; making loud noise from other mechanical or artificial noise making devices; artificial predator calls; and daily clean up and power washing of grackle droppings.

In one aspect, the invention includes a method for repelling, relocating and averting grackles and other roosting birds from trees and/or other vegetation. The method is implemented by installing a mechanically operated device horizontally to the main trunk of the tree and extending vertically along the tree trunk axis all the way to the highest point of the canopy of the tree where the grackles/birds roost or nest in trees. The device moves in a rotary manner which causes the moving rods and parts to rattle, agitate, and hit against tree limbs and branches located in the canopy of the tree where the birds roost or nest. The action, force and interaction of the device with the tree causes the limbs, branches and leaves of the tree to move and rustle, and also produces a low decibel sound emanating from the whipping and turning of the device extensions rods in the area of the tree canopy. The period of time during which the method and device are operated can be permanent or intermittent based on a motor timer mechanism that comprises a part of the device. The combination of timed tree movement, rustling, and sounds being emanated by the moving parts of the device causes the grackles to fly away from the roosting tree and, based on field tests, surrounding trees as well. The grackles do not return to the trees because of the ongoing operation of the device as determined by timer mechanism.

Another aspect relates to a system and apparatus installed horizontally to the main trunk of a tree and extending vertically along the tree trunk axis all the way to the highest point of the canopy of the tree where the grackles/birds roost or nest in trees. The moving parts of the apparatus rattle, agitate, and hit against tree limbs and branches and such actions and movements causes the tree limbs, branches and leaves to move and rustle, and also produces low decibel sounds emanating from the whipping and turning of the device extensions rods in the tree canopy. The period of time during which the method and device are operated can be permanent or intermittent based on a motor timer mechanism that comprises a part of the device. The timed tree movement and rustling combined with the sounds being emanated by the moving parts of the device causes the grackles to fly away from the roosting tree and, based on field tests, surrounding trees as well. The grackles do not return to the trees because of the ongoing operation of the device as determined by timer mechanism.

With reference to FIG. 1 of the drawings, a mechanical bird repellant in accordance with this invention, generally designated as reference 1 thru 20 includes an electric motor 5 at one end fastened with 8 angle bracket that is fastened to a vertical 11 uni-strut element which provides the general structural support of this invention. Included at this end are shown the reference designated 1 a diameter of rod sufficient to insert within the diameter of 2 a rod diameter sufficient to insert within the diameter of reference designated 3. The reference designations 1, 2, and 3 are represented per FIGS. 3, 4, and 5 wherein reference designations 1, 2, and 3 are inserted and retained within 10 tee. The 4 is depicted as connected to electric motor 5 and mechanically rotates creating a interference contact with 1, 2, and 3. The electric motor is wired electrically 18 having a connection to motor while routed within the structural support 11 transverse to the opposing end with electric plug 18 affixed end. The plug end of electric motor 5 plugs into 19 timer that is plugged from 20 an transformer converting Alternating current to Direct current. The reference designation 21 refers to an external power source I.e., a solar, battery and or conventional utility service providers.

With reference to FIG. 2 of the drawings, a mechanical bird repellant in accordance with the invention is generally indicated by reference numerals 1, thru 6 and 8 thru 11 with 13, 14, 16 and 17 depicted. The electric motor 5 fastened to 11 with extended arm 4 connected to the drive end of the electric motor 5. The extended arm 4 rotates clock wise and interferes with 1, 2, and 3 rods as retained in the tee 10 while movement of 1, 2, and 3 rods when rotation of 4 contacts 1, 2, and 3 rods. The 1, 2, and 3 rods are retained additionally between 6 rubber sleeve comprising inserted threaded rod with retaining nuts 14 at both ends of 6 rubber sleeves. The rubber sleeve 6 and threaded rod 16 are affixed thru a rectangular steel bracket plate 17 that is welded in the upper end of 11 uni-strut. The rod 16 is retained within a channel bracket 9 and having threaded ends to restrain in position 16 with nuts 14. The 16 rod is inserted with 10 a tee having a hollow internal hole located centrally on the axis of 16 with two 13 loose washers at each axis end of 16 rod.

With reference to FIG. 3 of the drawings, a mechanical boot in accordance with the invention is generally indicated with 10 tee that has sufficient mechanical movement horizontally per the axis of 16 allowing rods (not shown) 1, 2, and 3 horizontal movement along the axis of 16 while being forced by the interference of the extended arm 4 as it rotates when the electric motor (not shown) is energized. The tee 10 and two washers 13 have sufficient movement horizontally to allow the rods (not shown) 1, 2, and 3 to create a rattling noise from movement created by the interference of the arm (not shown) 4 as it rotates. The assembly of references 10, 13, 16, 14, and bracket 9 are held in place with angle bracket 12 and bolt with nuts 15 securing this assembly below the electric motor (not shown) bracket 8 to the unit-strut 11 support post. The channel bracket 9 is mounted to angle bracket 12 by means of bolt and nut 15 which provides adjustment of the (not shown) 1, 2, and 3 rods movement. The interference of arm 4 moving (not shown) 1, 2, and 3 creates sufficient noise from this mechanical movement providing additional noise from the washers 13 rattling horizontally on the 16 rod axis.

With reference to FIG. 4 of the drawings, a mechanical boot tee in accordance with the invention is generally indicated with 10 affixed to 11 uni-strut with angle bracket 12 while being affixed to channel bracket 9 with bolt and nut 15. The mechanical boot tee 10 is held in a horizontal position with a rod 16 with threaded ends while being retained within the channel bracket 9. The mechanical boot tee 10 maintains the vertical position of rods (not shown) 1, 2, and 3 at the same time restricting movement of mechanical boot tee 10 horizontally to allow the horizontal movement of rods (not shown) 1, 2, and 3 to create a rattling noise and movement of rods (not shown) 1, 2, and 3 as created from the interference of the rotating arm (not shown) 4 when the electric motor (not shown) is energized and rotates arm 4 and interfering with rods (not shown) 1, 2, and 3 forcing the rods (not shown) 1, 2, and 3 to travel horizontal to the vertical axis of 11 uni-strut support. With each rotation of arm (not shown) 4 the interference with rods (not shown) 1, 2, and 3 creates the horizontal movements and rattling noise repelling birds from trees, or other structures where this invention is installed and energized.

With reference to FIG. 5 of the drawings, a mechanical boot tee in accordance with the invention is generally indicated with 10 depicted with assembly of rod 16 fastened between the channel bracket 9 with two washers 13 assembled on the horizontal axis of rod 16 and located each opposing horizontal end of mechanical boot tee 10. The horizontal movement of 10 tee is sufficient to freely move when the rods (not shown) 1, 2, and 3 are moved horizontally during rotation of (not shown) arm 4. The channel bracket 9 and angel bracket 12 are affixed to 11 uni-strut with bolts and nut 15 located below the electric motor 5 (not shown).

With reference to FIG. 6 of the drawings, a mechanical bird repellant in accordance with this invention, generally designated as reference 1 thru 18. The reference 1, 2, and 3 are rods of varied lengths and diameters that provide the ability to insert one rod into another creating an assembly of rods that are held vertically by means of a mechanical boot tee 10 that is located at one end of rods 1, 2, and 3. The drawing FIG. 6, illustrates the assembly of a rotating arm 4 secured to the rotating shaft of electric motor 5 by means of angle bracket 8 secured to 11 with bolt and nut 15. The metal rods with rubber sleeves 6 having threaded ends retained at one end the rubber sleeve and rod 6 while the opposite end is retained and held in place with a rectangular bracket 17 welded to the electric motor 5 end of the structural support 11. The rods with rubber sleeves 6 restrain the lateral movement of vertically held rods 1, 2, and 3. The restrained movement of 1, 2, and 3 allow a spring back action when interference created from the rotating arm 4 as it contacts and forces 1, 2, and 3 rods to move both horizontal to the axis of 11 uni-strut and lateral movement between the rods with rubber sleeves 6. The electric motor 5 electric wiring 18 is routed within the uni-strut 11 support from the electric motor 5 end towards the bottom of the unit-strut 11 and exiting with a electrical plug end affixed to the end of the electric wiring 18. The electric motor 5 is fastened to angle bracket 8 via bolt and nut 14. The lower assembly that comprise the mechanical boot tee 10 and affix this assembly to support 11 are channel bracket 9, washers 13, bolt and nuts 14 and 15, angle bracket 12 with bolt and nut 15. The support uni-strut 11 provides for mounting or affixing and securing to structures or trees as installed unit utilizing common tie strap means of fastening. The timer 19 (not shown) facilitates a method of control of mechanical operation durations. The 20 transformer alternating current to direct current (not shown) may be required to regulate typical line voltage 21 (not shown) as provided by utility companies for electric motor 5 power source.

With reference to FIG. 7 of the drawings, a mechanical bird repellant in accordance with this invention, generally designated as reference 1 thru 18. The reference 1, 2, and 3 are rods of varied lengths and diameters that provide the ability to insert one rod into another creating an assembly of rods that are held vertically by means of a mechanical boot tee 10 that is located at one end of rods 1, 2, and 3. The drawing FIG. 6, illustrates the assembly of a rotating arm 4 secured to the rotating shaft of electric motor 5 by means of angle bracket 8 secured to 11 with bolt and nut 15. The metal rods with rubber sleeves 6 having threaded ends retained at one end the rubber sleeve and rod 6 while the opposite end is retained and held in place with a rectangular bracket 17 welded to the electric motor 5 end of the structural support 11. The rods with rubber sleeves 6 restrain the lateral movement of vertically held rods 1, 2, and 3. The restrained movement of 1, 2, and 3 allow a spring back action when interference created from the rotating arm 4 as it contacts and forces 1, 2, and 3 rods to move both horizontal to the axis of 11 uni-strut and lateral movement between the rods with rubber sleeves 6. The electric motor 5 electric wiring 18 is routed within the uni-strut 11 support from the electric motor 5 end towards the bottom of the unit-strut 11 and exiting with a electrical plug end affixed to the end of the electric wiring 18. The electric motor 5 is fastened to angle bracket 8 via bolt and nut 14. The lower assembly that comprise the mechanical boot tee 10 and affix this assembly to support 11 are channel bracket 9, washers 13, bolt and nuts 14 and 15, angle bracket 12 with bolt and nut 15. The support uni-strut 11 provides for mounting or affixing and securing to structures or trees as installed unit utilizing common tie strap means of fastening. The timer 19 (not shown) facilitates a method of control of mechanical operation durations. The 20 transformer alternating current to direct current (not shown) may be required to regulate typical line voltage 21 (not shown) as provided by utility companies for electric motor 5 power source.

With reference to FIG. 8 of the drawings, a mechanical bird repellant in accordance with this invention, generally designated as reference 1 thru 20 includes reference designation 22 a typical tree structure wherein reference designation 23 depicts the upper tree canopy. Support uni-strut 11 is attached to the tree trunk 22 by the use of any suitable fastener such as zip ties, u-bolts, hose clamps, wood screws or other fasteners. Ideally, the support uni-strut 11 is attached to the tree trunk 22 at a point such that the main motor 5 is just below the first level of the tree's main branch structure 23.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent methods, processes, apparatuses and products.

What I claim as my invention is:

1. A method of repelling, averting and relocating grackles from trees in which they roost by continuously or intermittently (i) causing limbs, branches and leaves in the tree to move, rustle and make sounds and (ii) creating low decibel noises and sounds to be emitted which scares the grackles and disrupts their natural tree roosting environment.

2. The method of claim 1, wherein the step of repelling and averting the grackles includes an electrical powered apparatus for mechanically repelling birds, comprising length of structural support having at one end the electrical operated horizontal rotation system that interferes with a vertical held system of rods attached to the structural support by means of a mechanical boot system retained below the mechanical rotation system with the electrical wiring being routed within structural support exiting opposite end and having electrical connector connected to external regulated direct current power source coupled with a timer capable of unattended operation.

3. A apparatus for mechanically repelling grackles and birds according to claim 1 and 2, wherein said arrangement of rods comprised of varying outer and inner diameters capable of being positioned one inside the other creating a system whereby when electrical activation of the rotation system mechanically interferes with these rods produces both a rattling sound and waving motion of the rods thereby repelling birds.

4. A apparatus for mechanically repelling birds according to claims 1, 2 and 3, wherein comprises vertical held system of rods being located between two horizontal rods affixed each side of the structural support located below the electrical rotating system retaining these rods, and restricting the horizontal movement of rods within this space.

5. A apparatus for mechanically repelling birds according to claim 1, 2, 3 and 4, wherein further comprises of a bracket located below a rotation system and affixed to the structural support retaining a mechanical boot being a tee with a threaded bolt located thru the boot tee capable of restricting horizontal movement when the rods encounter the rotational interference with the mechanical arm rotating by means of the electrical rotation system.

6. A apparatus for mechanically repelling birds according to claims 1, 2, 3, 4 and 5, wherein further comprises two large diameter washers affixed to each side of the mechanical boot tee and have free travel sufficient to allow washers and tee to travel back and forth horizontally while partially restricting the movement of the vertical rods held in place when inserted into and retained by the boot tee providing additional bird repelling noise from the loose washer motion interference with bracket and tee.

7. A apparatus for mechanically repelling birds according to claim 1 and 2, wherein comprise length of structural support capable of being mounted by any means to trees and or any structure and connected to a timed power source controlling the activation time of this apparatus.

8. A apparatus for mechanically repelling birds according to claim 1, wherein comprise an method of preferred placement of the apparatus within the trunk and tree branch structure to be installed horizontally to the main trunk of tree and extending vertically along the tree trunk axis all the way to the highest point of the tree canopy while maintaining sufficient distance from ground level to an approximate height that a normal person may secure and or fasten bird repelling apparatus with the coupled timer to power source. Ideally, the support uni-strut 11 is attached to the tree trunk 22 at a point such that the main motor 5 is just below the first level of the tree's main branch structure 23.
